(19) United States
(12) Patent Application Publication
(10) Pub. No.: US 2020/0263684 A1
(43) Pub. Date: Aug. 20, 2020

(54) FLUID PUMP HAVING A PISTON AND A SUPPORTING BODY BEARING THE PISTON FOR SEALING

(71) Applicant: Agilent Technologies, Inc., Santa Clara, CA (US)

(72) Inventors: Bernhard Dehmer, Rastatt (DE); Andre Lichtenberger, Waldbronn (DE)

(21) Appl. No.: 15/781,647

(22) PCT Filed: Dec. 15, 2016
(86) PCT No.: PCT/IB2016/057665

§ 371 Date: Jun. 5, 2018

(30) Foreign Application Priority Data
Dec. 16, 2015 (DE) 10 2015 121 968.9

(51) Int. Cl. F04B 53/02; F04B 53/14; F16J 15/16; B23P 15/08

(52) U.S. Cl. CPC F04B 53/02; B23P 15/08; F16J 15/16; F04B 53/143

(57) ABSTRACT

A fluid pump for pumping fluid in a sample separation device includes a pump body device, a piston arranged for conveying fluid in a reciprocable manner in the pump body device, a seal arranged fluid-sealingly in contact with and between the pump body device and the piston, and a supporting body, which is coupled to the seal for supporting the latter. The supporting body is arranged at the pump body device, thereby forming a bearing for the piston.

### TECHNICAL BACKGROUND

The present invention relates to a fluid pump as well to a sample separation device and a manufacturing method.

In a HPLC, typically, a liquid (mobile phase) is moved through a so-called stationary phase (for example in a chromatographic column) at a very precisely controlled flow rate (for example in the range of microliters to millilitres per minute) and at a high pressure (typically 20 to 1000 bar and exceeding thereover, presently up to 2000 bar), at which the compressibility of the liquid may be perceptible, in order to separate individual components of a sample liquid brought into the mobile phase. Such a HPLC system is known, for example, from EP 0,309,596 B1 of the same applicant, Agilent Technologies, Inc.

The pump, which conveys the mobile phase with the high pressure, may comprise in a pump body device a piston, which reciprocates (or moves back and forth) therein, and which provides the displacement of the fluid. Between the piston and the pump body device, there is a gap, which is sealed by a seal. It has turned out that, at high pressures, the seal and the piston are exposed to a high load (or high wear) and wear quickly.

WO 2012/122977 A1 discloses a piston-cylinder-unit for a piston pump for the high-performance-liquid chromatography (HPLC). In a cylinder housing, there is provided a recess (or opening) in which a piston is guided slidably. In a rearward area, the recess widens, wherein in this area there is provided an annular sealing element, through which the piston extends. In order to prevent at high pressures that the sealing element deforms and thereby looses its sealing effects, an annular supporting element is arranged at the rearward side of the sealing element, which supporting element is pierced by the piston. The guiding element is fabricated with sufficiently low tolerances, such that practically no or at most a very small annular gap results both with respect to the piston piercing through the supporting element and with respect to the inner wall of the widening area of the recess. At this time, it must be ensured that no or at most a low friction is generated between the inner wall of the supporting element and the outer circumference of the piston. WO 2012/122977 A1 emphasizes that the annular gaps mentioned before are so large that even at high pressures there is no danger that the sealing element is destroyed in result of a pressing, into the annular gap or that the sealing effect of the sealing element is lost. The supporting element is to receive pressure forces or tensions and is to withstand them, which are exerted by a pressure in the cylinder volume via the sealing element—hence in an axial direction.

### DISCLOSURE

It is an object of the invention to enable a low-wear fluid pump. The object is solved by the independent claims. Further embodiment examples are shown in the dependent claims.

According to an exemplary embodiment example of the present invention, there is established a fluid pump for pumping fluid (i.e. a liquid and/or a gas, optionally having solid matter particles) in a sample separation device (in particular in a liquid chromatography device), wherein the fluid pump has: a pump body device (which may also be referred to as a pump body or as a piston chamber or as a pump housing, and which may be formed from one or plural pump body components; the pump body device may define at least partially a fluid conveying space, in which a piston can displace and convey the fluid), a piston, which is arranged in the pump body device for conveying fluid in a reciprocable manner (that is, configured to move back and forth in the pump body device), a seal, which is arranged in contact with, and (in particular under high-pressure conditions) fluid-sealingly between, the pump body device and the piston, and a supporting body, which is coupled to the seal, thereby supporting the latter. In particular, the supporting body and the piston may be arranged such that they are, in operation of the fluid pump (i.e. during the conveying of a fluid), at least temporarily, in particular permanently, in touching contact with each other.

According to another exemplary embodiment example, there is established a sample separation device for separating in fractions a fluidic sample being in a mobile phase, wherein the sample separation device has a fluid pump having the features described above, which is configured for conveying at least one of the mobile phase and the fluidic sample (as the fluid that is pumped by the fluid pump) through the sample separation device, and a separation device downstream of the fluid pump for separating the different fractions of the sample being the mobile phase.

According to still another exemplary embodiment example, there is established a method for manufacturing a fluid pump for pumping fluid in a sample separation device, wherein, in the method, a piston is arranged in a reciprocable manner for conveying fluid in a pump body device, a seal is arranged in contact with, and fluid-sealingly between, the pump body device and the piston, a supporting body is provided, which is coupled to the sealing, thereby supporting the latter. Optionally, the supporting body and the piston can be arranged such that they are, in operation of the fluid pump, at least temporarily, in particular permanently, in touching contact with each other.

According to an exemplary embodiment example, a fluid pump is established, in which an at least temporary and/or at least piecewise (or section-wise) (i.e. in respect of space) a contact (or touch) is formed deliberately between the reciprocating (or moving back and forth) piston body and the supporting body, such that a gap arranged therebetween can be formed very small and/or at least piecewise diminishingly. This in turn makes it possible that a flexible or elastic mass (or matter) of the seal, which mass is pulled and/or extruded into the gap under high-pressure conditions can be significantly reduced. Thereby, an undesired overheating of the sealing film (or pellicle) of the seal in the gap, which skin gives way to the pressure, is prevented, such that no significant problematic melting of the latter and no bond of the piston surface with material of the seal can result. Thereby, the lifetime (or service life) of the pump, and in particular of the seal and the piston, can be increased significantly.

In the following, additional embodiments of the pump, the sample separation device and the method are described.

It is possible that the pump body device, the supporting body and the seal are provided as components, which are separate from each other, and which are held together, for example, only by a clamping force, which is generated by the connecting (for example, screwing together) of individual pump body components. Alternatively, however, it is also possible that, for example, the pump body device with the supporting body is formed in one piece or is fixedly connected (for example form-fit) and/or the seal with the supporting body is formed in one piece or fixedly connected (for example, via adhesion forces).

According to an embodiment example, the supporting body can be arranged at the pump body device, thereby forming a, in particular stationary, bearing for the piston. Stated differently, the supporting body can be arranged at the pump body device as a, in particular stationary, bearing formed for the piston. Stated still differently, the supporting body forms a bearing for the piston, and accordingly is arranged at the pump body device. By forming the fixed bearing (or thrust bearing) according to the described embodiment example by the supporting body and not by the seal, a gap can be defined between the supporting body and the piston, and be formed very narrow. This in turn has positive effects on the service life (or life span) of the seal.

In the framework of the present application, a “bearing for the piston” can be understood to refer in particular to a mechanical embodiment of the supporting body, which limits the free moving space of the piston in a predefinable and defined manner. Thus, a spatial guiding function for the piston is attached to a supporting body that is formed as a bearing. Such a bearing has the technical function to guide the piston in a position-controlled manner (or with automatic positioning) and to take up (or receive) external forces that are effective in at least one defined plane and to transmit to the pump body device and/or to the pump housing. In particular, the supporting body may also be referred to as a bearing for the piston, which supports the seal.

According to an embodiment example, the bearing can be a radial bearing, in particular a radial bearing related to the movement of the piston. In this connection, a radial bearing is understood in particular such that the supporting body guides the piston in its axial reciprocal movement and/or limits the piston in its non-axial or radial degrees of freedom of movement, such that a deflection of the piston in a radial direction (i.e. an offset of the piston parallel to its axial orientation and/or to a target direction of its reciprocal movement) is suppressed or even made impossible. An inclination (or tipping) of the piston, i.e. an angular deviation to the target reciprocal direction (or target direction of the reciprocal (or back and forth) movement) in the radial bearing plane, can be strongly limited or also prevented totally. Stated differently, a radial bearing, which is formed by the supporting body, can be formed for taking on (or receiving) radial transverse forces that may influence the piston. If the piston is formed for example as a body with substantially constant radius (or substantially cylindrical body), the axial direction corresponds to the cylinder axis of the piston and the radial directions to the extension directions perpendicular thereto (to the axis) in a circular cross-section. Thus, for a radial bearing, the supporting body can take on (or receive, or absorb) radial forces that influence the piston and deviate them (the forces) to the pump body device and thus predefine an axially stationary, radially limited pervasion plane of the piston in the pump body device. In particular, the supporting body (in particular a supporting ring) can be configured as a radial bearing, which holds a gap between the supporting body and a piston surface as narrow as possible, and which allows the piston surface to reach a permanent or at least temporary physical contact with the opposing surface of the supporting body according to existing radial bearing forces.

According to an embodiment example, the seal can be formed to be arranged, in operation of the fluid pump, at least temporarily and at least partially in a remaining gap between the supporting body and the piston. In the presence of a high pressure in the pump body device, the seal has the tendency to give way to the pressure and thereby to be pulled in a piecewise residual (or remaining) gap between the piston and the supporting body, which gap can be pressure-connected (or in pressure communication) with the low pressure side. According to the described embodiment example, indeed, a certain amount of the material of the seal may, under high pressure conditions, be pulled into the gap, which however can be formed particularly small due to the described embodiment. The amount of material of the seal, which is pulled into the gap, is thus also small. Thus, problems with the material of the seal, which is melted and contaminates the piston, can be suppressed or eliminated.

According to an embodiment example, a first surface section of the piston, which is, in operation of the fluid pump, at least temporarily in touching contact with the supporting body, can be hardened, in particular have a hardening coating. In a corresponding manner, alternatively or in addition, a first surface section of the supporting body, which, in operation of the fluid pump, is at least temporary in touching contact with the piston, can be hardened, in particular have a hardening coating. If the piston and the supporting body are in contact at least temporarily and/or piecewisely, in particular permanently, measures for suppressing a formation of scrapers on the piston are particularly advantageous. A hardening of the surfaces of the supporting body and the piston, which surfaces are in contact with each other, avoids a scratching of the piston and increases the service life of the pump. A precisely defined setting of the degree of hardness is possible by a coating for hardening the surfaces.

According to an embodiment example, the hardened first surface section of the supporting body and the hardened first surface section of the piston may have the same hardness, in particular may be formed from the same material. This has the advantage that when a rubbing on each other the hardened surfaces of the supporting body and the piston, none of the two surfaces is scratched or damaged by the respective other surface, which is respectively equally hard.

According to an embodiment example, a second surface section of the piston, which, in operation of the fluid pump, is at least temporary in touching contact with the seal, can be thermally highly conductive, in particular have a thermal conductivity of at least 200 W/mK, in particular of at least 1000 W/mK. In a corresponding manner, alternatively or in addition, a second surface section of the supporting body, which, in operation of the fluid pump, is at least temporarily in touching contact with the seal, can be thermally highly conductive, in particular have a thermal conductivity of at least 200 W/mK, further in particular of at least 1000 W/mK. The mentioned second surface sections of the piston and of the supporting body may be in particular those, between which a small gap is formed between the supporting body and the piston, into which material of the seal is pulled under high pressure conditions. Now, if the second surface sections, which are arranged opposite to each other (or even only one of these second surface sections), is furnished with a thermally highly conductive property (in particular by a corresponding surface coating), then heat from sealing material, which is extruded into the gap and heated, can be dissipated highly effectively and the sealing material can be protected from an undesired melting. Such a melting is considered also as the cause of the conventionally observed, undesired settling (or accumulation) of spots of the sealing material on the piston. Thereby, the wearing of the seal (by loss of material) and of the piston (by surface deposits) is reduced significantly.

According to an embodiment example, the hardened first surface section and the thermally highly conductive second surface section of the piston may be formed as a common (in particular identical, thus made of one material) coating. In particular, the first surface section of the piston and the second surface section of the piston may merge (or pass over into each other), or may even be partially identical or completely identical. Providing the whole piston or a defined surface section of the same with one and the same thermally highly conductive hardening coating is simple from the manufacturing standpoint and functionally highly effective. An effective scratch protection can thereby be combined with an efficient avoidance of the contamination by melting sealing material.

The first surface section of the piston and the second surface section of the piston can be totally different surface sections of the piston, can be totally identical surface sections of the piston, or can be partially different and partially identical surface sections of the piston.

According to an embodiment example, the hardened first surface section and the thermally highly conductive second surface section of the supporting body may be formed as common (in particular identical, thus made of one material) coating. In particular, the first surface section of the supporting body and the second surface section of the supporting body may merge directly (or pass over into each other directly), or even be partially identical or totally identical. Providing the whole supporting body or a limited surface section with one and the same thermally highly conductive hardening coating is simple from the standpoint of manufacturing. A scratch protection can thereby be combined with an avoidance of the contamination by melting sealing material.

The first surface section of the supporting body and the second surface section of the supporting body can be totally different surface sections of the supporting body, can be completely identical surface sections of the supporting body, or can be partially different and partially identical surface sections of the supporting body.

According to an embodiment example, the seal may be formed (as a seal that surrounds the piston annularly) as an annular sealing flange that adjoins the supporting body and an annular lip area that adjoins the piston and the pump body device. The sealing flange can be formed onto (or shaped integrally on) one side of a solid and central sealing shaft, onto the other side of which the annular lip area (which may comprise an inner sealing lip and an outer sealing lip) may be formed (or integrally shaped). The sealing flange serves an interface to the supporting body and can be pressed onto the latter and positions the seal axially. The sealing shaft renders a sufficient stability to the seal. The lip area, which may be formed from the same material as the sealing shaft and the sealing flange, may be formed significantly thinner and thus significantly more flexible and/or more elastic than the sealing shaft, in order to snuggle sealingly to the pump body device and/or to the piston. The lip area forms a hydraulic hollow space and/or confines the latter, in that a radial force on the outer sealing lip and the inner sealing lip of the lip area may arise from the differential pressure (or pressure difference) between the fluid conveying space and the surrounding. Thus, at higher pressures, the lip area becomes hydraulically self-sealingly.

According to an embodiment example, the fluid pump can have an elastic component part (or assembly part) (in particular a spring, further in particular a spiral spring), wherein the elastic component part is arranged at least partially in the hydraulic hollow space between the outer sealing lip and the inner sealing lip. Such an arrangement of the seal and the elastic component part may accomplish the sealing effect due to the elastic component part at low pressures with a not yet distinctive hydraulic sealing effect.

According to an embodiment example, the supporting body can be formed as a supporting ring that encloses the piston annularly. Such a supporting ring may be formed rigidly, and may be manufactured, for example, at least partially of plastic, metal or ceramic. A metallic, ceramic or polymer base body of the supporting body may, however, be coated on its surface with the thermally highly conductive hardening coating mentioned above.

According to an embodiment example, the supporting body and the piston may be arranged radially so close to each other that they have a maximum distance in a range between 10 μm and 200 μm, in particular in a range between 10 μm and 50 μm, preferably between 5 μm and less than 20 μm. A supporting body that is, for example, formed as a ring and a piston that is, for example, with constant radius (or with single center, or in other words cylindrical) can, in operation, be arranged slightly eccentrically to each other at least temporarily, such that a direct contact between the supporting body and the piston occurs in a first circumference section, whereas in another circumference section a spaced relationship (or a spacing) between the supporting body and the piston remains (see for example FIG. 6). This may, according to the described embodiment example, at a position of maximum distance, be in particular in the small range between 5 μm and 50 μm, whereby it is ensured that only a most thin sealing skin (or film) can extrude in the area between the supporting body and the piston. This reduces the wearing of both the seal, which thereby tends less to extrusion, and also the piston, which is clogged (or coated) less with spots of sealing material that is melted and solidified again on the surface of the piston.

According to an embodiment example, the pump body device may have a first housing part (which may form a pump head) having a fluid conveying space in fluid connection with a fluid intake and a fluid outlet as well as a second housing part (which may also be referred to as pump cap) for receiving the supporting body. The first housing part and the second housing part may be formed combinable with (or connectable to) each other pressure-resistently and fluid-resistently with a seal arranged therebetween, for example by a screwed joint, a bayonet joint, a plug connection or a welded joint.

According to an embodiment example, the seal may comprise a polymer, such as polyethylene, in particular polyethylene having an ultra-high molecular weight, or consists thereof. Such high-molecular (or of high molecular weight) polyethylene material has very long polymer chains, which results in a permanent high ductility. This material also fulfils the requirements as to chemical stability, which is undispensable in a fluid pump for chromatography applications due to the solvents and/or solvent compositions to be pumped therein. Furthermore, the mentioned materials are sufficiently temperature-stable, in order to be able to be used up to 90° C. and more. Such a material has the capability to move sealingly into small gaps and to withstand non-destructively even high pressures of 1200 bar and more. For example, UHMWPE products from PSI with the product code Duron 14 or the sealing material from Saint-Gobain with the product code A09 can be used as suitable materials.

According to an embodiment example, the supporting body may comprise a hard plastic material, in particular polyaryletherketone (PAEK), further in particular at least one material from the group consisting of polyetheretherketone (PEEK), polyetherketone (PEK), Polyetherketonketone (PEKK) and polyetherketonetherketonketone (PEKEKK). Also, polyimide composites having good mechanical and chemical properties may be used. Also, a ceramic and/or a metal and/or hard metal may serve as a base material of the supporting body. The supporting body may thus have a much higher rigidity than the elastic seal. The use of a ceramic and/or of a metal, in particular a hard metal, as the base material for the supporting body is advantageous, in particular, if the supporting body is implemented as a bearing and/or if the supporting body and the piston touch each other at least temporarily.

According to an embodiment example, the piston may have at least one material from the group that consists of zirconium oxide, sapphire, hard metal and silicon carbide. The piston material may also be, for example, zirconium oxide (thermal conductivity 2.5 W/mK to 3 W/mK), sapphire (thermal conductivity approximately 35 W/mK), a hard metal (with different thermal conductivity) or sintered silicon carbide (thermal conductivity 120 W/mK to 160 W/mK). In particular, the lastly mentioned piston material having the highest thermal conductivity addresses the heat distribution behaviour of the piston particularly well, and is usable with advantage for the heat distribution gap according to an embodiment example of the invention. The mentioned materials fulfil the high mechanical robustness requirements of a high-pressure pump and, in addition, have a high thermal conductivity, with which also the heat amounts that occur during high-pressure operation can be dissipated (or transported away) efficiently.

According to an embodiment example, the supporting body and/or the piston may have a coating of polycrystalline diamond, in particular of smoothed (or graded, or abraded) polycrystalline diamond. The polycrystalline diamond material may be applied for example with a thickness in a range between 5 μm and 20 μm. Such a diamond coating can be formed as a multi-layer diamond. According to this preferred embodiment example, the hardest available material, namely polycrystalline diamond, can be used, in order to make impossible the formation of scratches on the supporting body and the piston. By smoothing the polycrystalline diamond material, a mutual polishing of the mutually touching diamond faces (or surfaces) in operation and the abrasion connected therewith can be avoided. Thereby, in addition, the friction coefficient between the touching surfaces of the supporting body and the piston, which are in contact with each other, are improved extremely.

If the supporting body and/or the piston is provided with a coating of polycrystalline diamond, the coating can be smoothed advantageously ablatively (i.e. by ablation). For example, a smoothing (or grading) by laser processing, in particular by a femtosecond to picosecond laser, can be achieved. This results in very good tribological properties between the supporting body and the piston, and thus to an extremely little abrasion, and thus to a particularly high service life. The smoothing can thus be performed with advantage ablatively, in particular laser-ablatively. In addition, the laser ablation offers the possibility to set specifically the percentage contact area of the touching faces (or touching surfaces).

According to an embodiment example, structures can be placed (or yielded) on at least a surface section of the supporting body and/or the piston by laser ablation. Thus, also uniform or periodic (regularly recurring) structures or structures that are in an angular deviation to each other can be yielded on the surfaces. Thus, e.g. the percentage contact area at the supporting ring along the piston axis and the percentage contact area on the piston can be reduced in a thread-like (or helical) shape. The structures between the friction partners can be selected such that a mutual locking (or snapping) or catching, thus acting to increase friction, does not become possible.

Particularly advantageously, the supporting body and the piston may have a coating of diamond on a hard metal body. The mechanical properties, such as for example the ductility and stability of the material of these components, are particularly high in that case. Hereby, it is to be noted in particular that the diamond surfaces of the supporting body and the piston, which come in contact with each other, have the same hardness, and thus, irrespective of the contact, there must not be much fear of abrasion at these surfaces.

Such polycrystalline diamond material can be deposited process-technologically end position simply by deposition from the gaseous phase (CVD processes, “chemical vapour deposition”) on a core of a supporting body and/or a piston, and can be subjected, beside the laser ablation, also to a subsequent smoothing polishing (for example thermally, abrasively and/or chemically). The smoothing of polycrystalline diamond material can be performed, for example, abrasively by diamond powder or bonded diamond grains. Alternatively, the grading of the polycrystalline diamond material may also be effected thermally (for example, by a non-ablative laser treatment) and/or chemically.

According to an embodiment example, the fluid pump can be formed as a high-pressure pump for pumping a mobile phase to a separation device of the sample separation device for separating different fractions of a fluidic sample being in the mobile phase. Under high-pressure conditions, a pump according to an exemplary embodiment unfolds specific advantages with respect to wear protection.

According to an embodiment example, the separation device may be embodied as a chromatographic separation device, in particular as a chromatographic separation column. In a chromatographic separation, the chromatography separation column can be provided with an adsorption medium. The fluidic sample can be obstructed (or held up) at the latter and may be released fraction-wise again only subsequently in the presence of a specific solvent composition, whereby the separation of the sample into its fractions is effected.

The sample separation device may be a microfluidic measurement device, a Life Science device, a liquid chromatography device, a HPLC (High Performance Liquid Chromatography), an UHPLC apparatus, a SFC (supercritical fluid chromatography) apparatus, a gas chromatography apparatus, an electrophoresis apparatus and/or a gel electrophoresis apparatus. However, many other applications are possible.

The fluid pump may be configured for example to convey the mobile phase with a high pressure, for example some 100 bar up to 1000 bar and more, through the system.

The sample separation device may have a sample injector for bringing in the sample into the fluidic separation path. Such a sample injector may have an injection needle, which is coupleable with a seat, in a corresponding liquid path, wherein the needle can be driven out of the seat in order to receive the sample, wherein after the re-insertion of the needle into the seat the sample is located in a fluid path, which may be switched into the separation path of the system, for example, by switching a valve, which results in introducing the sample into the fluidic separation path.

The sample separation device may have a fraction collector for collecting (or gathering) the separated components. Such a fraction collector may guide the different components, for example, to different liquid containers. However, the analyzed sample may also be supplied (or conveyed) to a drainage container.

Preferably, the sample separation device may have a detector for detecting the separated components. Such a detector may generate a signal, which can be observed (or monitored) and/or recorded, and which is indicative for the presence and the amount of the sample components in the fluid that flows through the system.

### SHORT DESCRIPTION OF THE DRAWINGS

Other objects and many of the accompanying advantages of embodiment examples of the present invention will become easily perceivable and better understandable with reference to the following detailed description of embodiment examples in relation with the appended drawings. Features, which are substantially or functionally the same or similar, are provided with the same reference numerals.

FIG. 1 shows a HPLC system according to an exemplary embodiment example of the invention.

FIG. 2 shows a cross-sectional view of an inner pump housing of a sample separation device according to an exemplary embodiment example of the invention.

FIG. 3 shows a side view of an annular supporting body of the fluid pump according to FIG. 2.

FIG. 4 to FIG. 6 show details of the fluid pump according to FIG. 2.

The depiction in the drawings is schematic.

Before exemplary embodiment examples are described with reference to the figures, some basic considerations shall be summarized, based on which exemplary embodiment examples of the invention have been derived.

According to an exemplary embodiment example of the invention, in a pump seal of a fluid pump, mutually opposing surfaces of a piston and a supporting body, which is embodied, for example, as a bearing, are highly thermally conducting and scratch-resistant (which can be achieved simultaneously by a diamond coating). Thereby, it is possible to keep a gap between the piston and a supporting ring that surrounds the piston circumferentially as narrow as possible, and to predefine piecewisely even a touch (or contact) between the piston and the supporting ring and/or the bearing. Even for an at least temporary contact between the piston and the supporting body, there must not be much fear of an undesired scratch formation due to the diamond layer. Furthermore, even for a small dimension of the gap, a heat dissipation effected by thermal conduction of the seal material, which is extruded into the narrow gap and/or squeezed therein, is ensured, whereby in turn a melting or a further softening of the seal material, and in result a further undesired extruding of the seal material, can be impeded. Demonstratively, according to an exemplary embodiment example, a heat-distributing narrow gap is thus provided for a pump seal of a HPLC with simultaneous abrasion protection.

Many HPLC pumps, which are configured for a continuous transport of liquid, follow the principle of a longitudinal, bi-directional piston movement in the interior of a pump body device, which is connected with valves. If an inlet path and an outlet path of this pump body device open and close by switching the valves, a pressure increase, which goes along therewith, along the piston is held by a seal. A PTFE-based seal is usable up to pressures of about 600 bar. At pressures above 600 bar, for example 1200 bar and more, only very few polymer composites are suitable to satisfy the necessary chemical inertness and the load-carrying capacity under highest pressure conditions. In such an area of applications, polymeric seals of polyethylene material having an ultra-high molecular weight and specific additives can be formed advantageously. In order to withstand the axial pressure load, such polymer seals can be supported additionally by a rigid supporting ring at the rear side of the seal, in order to impede a penetration (or intrusion) of material of the seal in the direction of the pressure drop. Only a small gap close to the piston surface remains, if the inner diameter of this supporting ring is configured to adapt itself (or fit itself) as close as possible to the surface of the piston, however also at a sufficient distance in order to prevent a direct contact with the piston surface while the piston is moving. Conventionally, the supporting ring must be kept away reliably from the piston surface, in order to avoid deposition or scratches on the piston surface. Conventionally, the sleeve-shaped (or jacket-shaped) gap between the supporting ring and the piston surface defines substantially concentric thin walls, wherein sealing material is extruded into the gap at least partially under the system pressure and the piston movement.

In contrast to conventional approaches, exemplary embodiment examples of the invention avoid undesired depositions or scratches on the piston surface. Furthermore, it is possible with exemplary embodiment examples of the invention to loose significantly less sealing material due to pressure-induced extrusion of sealing material into the gap between the supporting ring on the one hand and the piston surface on the other hand. An undesired melting of sealing material and a subsequent deposition of the same on the piston surface can be strongly reduced (for example, at least by a factor of ten), or avoided totally by exemplary embodiment examples of the invention. In this manner, according to exemplary embodiment examples of the invention, for HPLC pumps, which are advantageously provided with a seal of polyethylene having an ultra-high molecular weight or the like, the limit of the possible system pressure, the maximum achievable piston velocity, and the service life can be increased significantly.

According to an exemplary embodiment example, this can be realized with an outstanding performance by the combination of a specific design and a specific heat distribution material on a contact surface for the seal.

Firstly, the specific design is described. As has been explained above, in a conventional implementation, the supporting ring only supports the seal and must not have a contact at all or only temporarily little contact to the piston itself. A shaft of the seal conventionally serves as a radial bearing and keeps the supporting ring away from the piston surface at the very most and without large contact forces, however, causes an unfavourable gap between the sealing ring and the piston surface. In contrast to this, according to an exemplary embodiment example of the invention, the supporting ring can be configured as a radial bearing, which keeps the gap between the supporting ring and the piston surface as narrow as possible and allows the piston surface to get in permanent or at least temporary physical contact with the opposing surface of the supporting ring according to the existing radial bearing forces. For this purpose, it is advantageous that the materials of the piston and the supporting ring, which get in contact with each other, are very resistant (or hard-wearing) in respect of wearing, such that a formation of scratches on the piston surface is not arrived at. This can be combined advantageously with a low-friction behaviour in the contact area of the supporting ring and the piston surface. For example, a smoothed, polycrystalline diamond coating both on the piston surface and also on the opposing surface of the supporting ring can satisfy all these requirements in an excellent manner. Such a coating can be formed on the piston and the supporting ring with a CVD coating method and a subsequent smoothing (or grading). Also, since polycrystalline diamond has the maximum achievable hardness among all known materials, no scratches can generated on the piston surface. Depending on the implementation of the polycrystalline diamond layer, a subsequent smoothing method may also be dispensed with.

In the following, the specific heat distribution material is described. In a conventional implementation (or formation) of the material of the plastic ring at the rear side of the seal, this material has a moderate thermal conductivity of, for example, only approximately 1 W/mK. Conventionally, frictional heat, which is accumulated in a high-pressure operation, at the seal thus cannot be effectively dissipated. Experimental results show that conventionally, due to the limited operational temperature for sealing materials and the high frictional temperature within the unfavourable gap between the supporting ring and the piston surface, the sealing material, which is squeezed therein, melts onto the piston surface at least in the form of small points (or dots) and may result in a very fast wearing of the seal. These disadvantages can be overcome or at least mitigated with exemplary embodiment examples of the invention. An exemplary embodiment example of the invention provides a very thin heat distribution gap on both sides of the sealing material, which extrudes into the gap between the supporting ring and the piston surface due highest system pressures above 1000 bar or the like. If both walls of the narrow, sleeve-shaped gap are manufactured from polycrystalline diamond having a thermal conductivity of approximately 2000 W/mK or are covered therewith, undesired excessive heat can be dissipated from a polyethylene seal having an ultra-high molecular weight or the like, and the service life of the seal can be increased dramatically, even if very high piston velocities and very high system pressures are implemented.

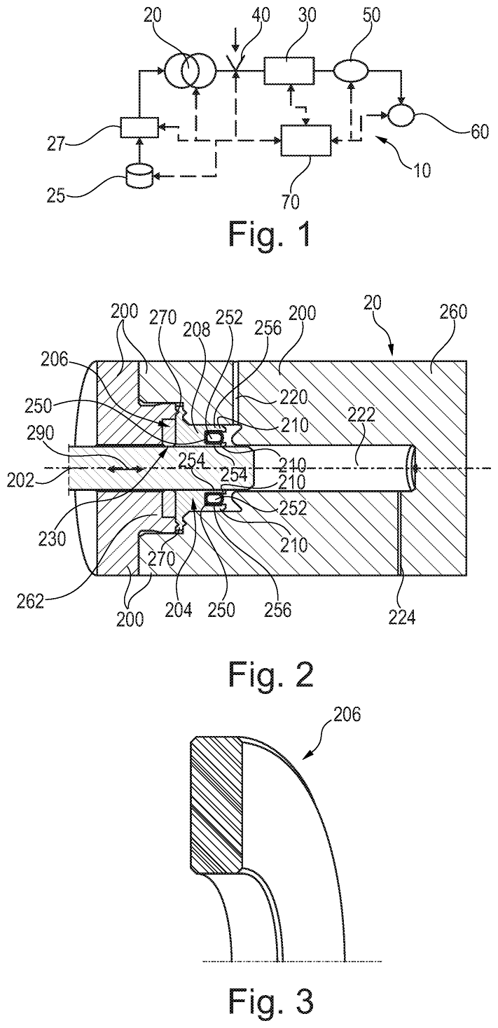

FIG. 1 shows the basic setup of a HPLC system as an example for a sample separation device 10, such as it is used, for example, for liquid chromatography. A fluid pump 20 as a fluid drive device, which is supplied with solvents from a supply unit 25, drives (or conveys) a mobile phase through a separation device 30 (such as, for example, a chromatographic column), which contains a stationary phase. A degasser 27 may degas the solvents before these are supplied to the fluid pump 20. A sample application unit 40 is arranged between the fluid pump 20 and the separation device 30, in order to introduce a sample liquid into the fluidic separation path. The stationary phase of the separation device 30 is provided in order to separate the components of the sample. A detector, see the flow cell 50, detects separated components of the sample, and a fractioning device can be provided in order to output separated components of the sample in containers provided therefore. Liquids that are no longer required can be output into a discharge container (or outlet container) 60.

A control unit 70 controls the individual components 20, 25, 27, 30, 40, 50, 60 of the sample separation device 10.

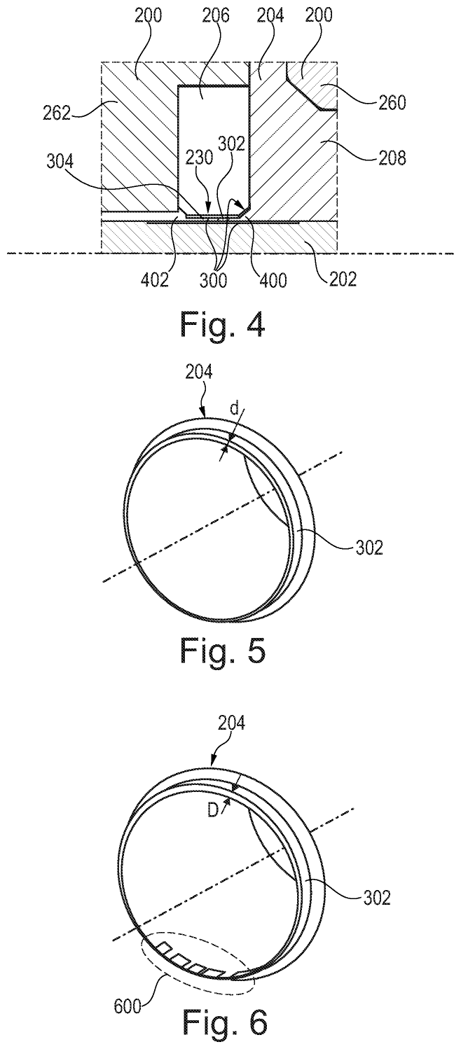

FIG. 2 shows a cross-sectional view of an inner pump housing of a fluid pump 20 according to an exemplary embodiment example of the invention. FIG. 3 shows a sectional view of an annular supporting body 206 of the fluid pump 20 according to FIG. 2. FIG. 4 to FIG. 6 show details of the fluid pump 20 according to FIG. 2: FIG. 4 shows, in a magnified representation, a border area between the piston 202, the seal 204 and the supporting body 206, and FIG. 5 and FIG. 6 show further perspective views of the seal 204 in this border area in different operational states.

In FIG. 2, the cross-section of the fluid pump 20 for pumping fluid (in particular a solvent or a solvent composition, for example water and acetonitrile) in a sample separation device 10, which is configured as a HPLC, is shown. The fluid pump 20 has a pump body device 200, which is herein formed and/or defined by a plurality of housing components. Stated more precisely, the pump body device 200 is formed of a first housing part 260 having a fluid conveying space 222 in fluid communication with a fluid inlet 224 (which is arranged, for example, downstream of a fluid valve (not shown)) and a fluid outlet 220 (which is arranged, for example, upstream of a further fluid valve (not shown)) as well as of a second housing part 262 for receiving (or accommodating) a supporting body 206. Alternatively, the second housing part 262 and the supporting body 206 can also be formed in one piece and/or as a common component part. The first housing part 260 (which may be manufactured, for example, from steel or ceramics) and the second housing part 262 (which may be manufactured, for example, also of steel or ceramics) with a seal 204 arranged therebetween are high-pressure-resistant (in particular at least high-pressure-resistant up to 1200 bar) and fluid-resistant (i.e. such that no appreciable leakage of the pumped fluid occurs) connected to each other (for example, screwed together to each other). The two housing parts 260, 262 can be implemented mechanically sufficiently robust so as to withstand highest pressures of up to 1200 bar and more. The first housing part 260 forms part of a pump head, whereas the second housing part 262 represents a pump head covering. The second housing part 262 cares, in a state mounted to the first housing part 260, for a firm termination of the fluid pump 20, and, demonstratively, sets itself rigidly against the pressure in operation. Fluid, which is supplied at the fluid inlet 224, is moved by a piston 202, which is movable back and forth in horizontal direction according to FIG. 2 (see double arrow 290) in the operating volume or fluid conveying space 222 (which is at a system pressure of, for example, 1200 bar) and is pumped to the fluid outlet 220 under high pressure. The fluid inlet 224 and/or the fluid outlet 220 may be connected operatively to one or plural valves, which are not shown in the figure. Thus, the piston 202 is arranged in the pump body device 200 in a reciprocable manner (or in a manner capable to move back and forth) for conveying fluid. A core of the piston 202 may, for example, be formed of thermally well conducting silicon carbide, which is at least in part functionally coated, as is described in more detail below.

Furthermore, the fluid pump 20 has the flexible or elastic, thus deformable for effecting a sealing effect, seal 204, which is arranged fluid-tight in contact with the pump body device 200 and the piston 202, and which is located between the pump body device 200 and the piston 202. The seal 204 is formed as a seal 204, which annularly (or circumferentially) surrounds the piston 202, and which has a sealing flange 270 that adjoins to the supporting body 206 and the second housing part 262, a central annular sealing shaft 208, and an annular lip area 210 formed onto the sealing shaft 208. The sealing shaft 208, which may be considered as a solid part of the visco-plastic seal 204, behaves, under system pressure, as a viscous hydraulic medium, which flows into cracks (or scars). The lip area 210 having an inner sealing lip 254 and an outer sealing lip 256 effects the sealing between the piston 202 and the first housing part 260. The sealing flange 270 lies form-fittingly on an annular contact face of the second housing part 262 and keeps the seal 204 in place. In the shown embodiment example, the seal 204, which is made of one material (or is of a one-material design), is formed of polyethylene having an ultra-high molecular weight. Due to its mechanically resilient material, the seal 204 is formed to be located, in operation of the fluid pump 20, at least temporarily and at least partially in a gap (see border area 230) between the supporting body 206 and the piston 202. Furthermore, an elastic component part 250 in the form of a spiral spring is arranged in an annular hollow space 252, which is only partially filled by the component part 250, between the mutually opposing inner and outer sealing lips 254, 256 of the lip area 210. At low pressures of some bar, an elastic force of the elastic component part 250 predominantly effects the sealing effect. By contrast, at high pressures of some hundred bar, a hydraulic force predominantly effects the sealing effect, which results from fluid, which is pressed into the hollow space 252 and which pushes the two sealing inner and outer sealing lips 254, 256 inwardly against the piston 202 and/or outwardly against the pump body device 200.

The rigid supporting body 206, which is represented magnified in FIG. 3 and which is formed as a PEEK ring, ceramic ring, hard metal ring or metal ring in the shown embodiment example, is coupled to the seal 204 and supports the latter. The supporting body 206 serves as an intermediate element, which prevents that heated-up and deformed material of the seal 204 extrudes, under the prevailing pressure, through a gap between the piston 202 and the second housing part 262. Furthermore, the supporting body 206 provides support to the seal 204. The supporting body 206 and the piston 202 are arranged such that they are, in operation of the fluid pump 20, at least temporarily, in particular permanently, in touching contact with each other. The supporting body 206 is arranged at the pump body device 200, thereby forming a stationary bearing for the piston 202. For this purpose, the annular supporting body 206 is accommodated in a front-side annular recess of the second housing part 262 (also referred to as chamber cap). In the border area 230 between the supporting body 206 on the one hand and the piston 202 on the other hand, there prevails ambient pressure or at least approximately ambient pressure.

In the detailed view of the inner pump housing according to FIG. 4, it is shown which conditions (or proportions) arise in the border area 230 between the piston 202, the pump body device 200, the seal 204 and the supporting body 206 in the presence of a high system pressure of, for example, 1200 bar. As is indicated with the reference numeral 302, material of the seal 202 is, under high pressure, pushed into an at least temporarily formed gap between the supporting body 206 on the one hand and the piston 202 on the other hand, and/or additionally pulled thereinto during the stroke of the piston 202 out of the fluid conveying space 222. As is indicated by the reference numeral 304, a very narrow, sleeve-shaped, heat-distributing gap forms at least temporarily between the supporting body 206 on the one hand and the seal 202 on the other hand.

According to FIG. 4, see reference numeral 300, the surface of the piston 202 is provided with a smoothed (or graded, or abraded) ultra-hard and thermally highly conductive coating, for example, a polycrystalline diamond layer, which is deposited by CVD and smoothed. In a corresponding manner, the surface of the supporting body 206 is provided with a smoothed ultra-hard and thermally highly conductive coating, for example polycrystalline diamond deposited by CVD and smoothed. Preferably, the two coatings on the piston 202 and on the supporting body 206 are identical. This has advantages: In the area corresponding to the reference numeral 304, in which no sealing material is present and a direct contact between the piston 202 and the supporting body 204 can arise, the both-sided, identical and ultra-hard as well as smoothed coating effects a low-friction contact of the mutually opposing contact faces of the piston 202 and the supporting body 206 and prevents the formation of scratches due to the identical hard contact faces. In the area corresponding to the reference numeral 302, in which material of the seal 204 is extruded into the narrow gap between the piston 202 and the supporting body 206 in the form of a thin film (or pellicle), the both-sided, thermally highly conductive coating effects a double-sided heat dissipation from the heated-up seal 204, and prevents that the latter softens undesirably under high-pressure conditions or is even liquefied. A damage of the seal 204 can thereby be obviated efficiently. In an area represented by the reference numeral 400, there prevails approximately system pressure (for example 1200 bar), whereas in an area represented by the reference numeral 402, there prevails ambient pressure (for example 1 bar). Due to this pressure gradient and/or pressure drop, there is effected an extruding of sealing material with formation of the film (or pellicle). The highly heat conductive hardening coating on the piston 202 and the supporting body 206 thus acts also synergistically as a scratch protection and a highly effective heat conductor, and thus as a heat sink for a seal section, which is in addition intensified by an enabled narrowed gap between the piston 202 and the supporting body 206, which in turn impedes additionally an undesired extruding and melting of sealing material. The result is a very low-wear fluid pump 20.

FIG. 5 shows a detail of the seal 204 in a viewing direction from the low pressure side (see reference numeral 402 in FIG. 4), and relates to the situation of the presence of a clearance or interstice (or gap) of circumferentially constant thickness d, in result of which there is presently no contact between the piston 202 on the one hand and the supporting body 206 on the other hand. There arises concentrically extruded material of the seal 204 due to the concentric gap between the supporting body 206 and the surface of the piston 202. FIG. 5 thus shows a concentric position.

FIG. 6 shows again a detail of the seal 204 in a viewing direction from the low pressure side, and relates to the situation, in which the piston 202 on the one hand and the supporting body 206 on the other hand are in touching contact with each other. There arises eccentrically extruded material of the seal 204 due to an eccentric gap between the supporting body 206 and the surface of the piston 202. In an area 600 there is no extruded sealing film at all due to a direct contact between the supporting body 206 and the piston 202, whereas a maximum thickness D of the sealing pellicle in a circumferentially opposite area may amount to, for example, 15 μm. In the area 600, the seal 204 is virtually transparent, i.e. there is presently, in the operational state shown, approximately no sealing material.

With the embodiment according to FIG. 2 to FIG. 6, it is possible to allow (or tolerate) an extremely small gap (which may become at least piecewise and/or at least temporarily zero and then may allow a touching contact) between the piston 202 and the supporting body 206. By this small or even dissappearing gap, an undesired extruding and subsequent melting of material of the seal 204 in this gap can be prevented or even eliminated. This increases the service life of the seal 204, because its material wears less quickly and/or detaches from the seal 204, and increases the service life of the piston 202, because less material of the seal 204 deposits in an undesired manner on the surface of the piston 202. The reduced and/or even disappearing gap acts synergistically together with the thermally highly conductive hardening coating (see reference numeral 300) of the corresponding sliding and/or touching surfaces of the piston 202 as well as the supporting body 206, because this hardening coating 300 ensures simultaneously a low-wear sliding of the sliding and/or touching surfaces on each other as well as an efficient heat dissipation of the thin, sealing film, which is extruded and formed by pinching, in a remaining narrow gap. This is possible particularly well with an extremely heat conductive and an extremely hard polycrystalline diamond layer as the hardening coating 300. The hardening coating is shown here by way of example only on the minimum necessary surface, may however also comprise the total surface of the supporting ring and/or the piston.

It should be noted that the term “having” (or “comprising”) does not exclude other elements, and that “a” or “an” does not exclude a plurality. Also, elements, which are described in relation to different embodiment examples, can be combined. It should also be noted that reference numerals in the claims are not to be construed as limiting the scope of protection of the claims.

1. A fluid pump for pumping fluid in a sample separation device, the fluid pump comprising:
a pump body device;
a piston arranged for conveying fluid in a reciprocable manner in the pump body device;
a seal arranged in contact with, and fluid-sealingly between, the pump body device and the piston; and
a supporting body coupled to and supporting the seal;
wherein the supporting body is arranged at the pump body device, thereby forming a stationary bearing for the piston, and
wherein the supporting body comprises a coating selected from the group consisting of: diamond; polycrystalline diamond; and smoothed polycrystalline diamond.

2. The fluid pump according to claim 1, wherein the supporting body and the piston are arranged such that the supporting body and the piston are, in operation of the fluid pump, at least temporarily in touching contact with each other.

3. The fluid pump according to claim 1, wherein the seal is formed to be arranged, in operation of the fluid pump, at least temporarily and/or at least partially, in a gap between the supporting body and the piston.

4. The fluid pump according to claim 1, wherein at least a first surface section of the piston, which is, in operation of the fluid pump, at least temporarily in touching contact with the supporting body, comprises a hardening coating.

5. The fluid pump according to claim 4, wherein at least a first surface section of the supporting body, which is, in operation of the fluid pump, at least temporarily in touching contact with the piston, comprises the coating, and the hardening coating of the at least first surface section of the piston is the same material as the coating of the at least first surface section of the supporting body.

6. (canceled)

7. The fluid pump according to claim 4, wherein at least a second surface section of the piston, which is, in operation of the fluid pump, at least partially in touching contact with the seal, is thermally highly conductive, in particular has a thermal conductivity of at least 200 W/mK.

8. The fluid pump according to claim 5, wherein at least a second surface section of the supporting body, which is, in operation of the fluid pump, at least temporarily in touching contact with the seal, is thermally highly conductive, in particular has a thermal conductivity of at least 200 W/mK.

9. The fluid pump according to claim 7, wherein the first surface section of the piston and the second surface section of the piston are formed by the hardening coating.

10. The fluid pump according to claim 8, wherein the hardened first surface section of the supporting body and the thermally highly conductive second surface section of the supporting body are formed by the coating.

11. The fluid pump according to claim 1, wherein the seal surrounds the piston annularly with an annular sealing flange that adjoins the supporting body and with an annular lip area that adjoins the piston and the pump body device.

12. The fluid pump according to claim 11, comprising an elastic assembly part arranged at least partially in a hollow space between an inner sealing lip and an outer sealing lip of the lip area, wherein the inner sealing lip and the outer sealing lip are arranged opposite to each other.

13. The fluid pump according to claim 1, wherein the supporting body is formed as a supporting ring that surrounds the piston annularly.

14. The fluid pump according to claim 1, wherein the supporting body and the piston are arranged such that they have a maximum distance in a range between 10 μm and 200 μm.

15. The fluid pump according to claim 1, wherein the pump body device comprises a first housing part having a fluid conveying space in fluid connection with a fluid intake and a fluid outlet, and a second housing part for receiving the supporting body, wherein the first housing part and the second housing part are formed with a sealing arranged therebetween to be connectable with each other pressure-resistantly and fluid-resistantly.

16. The fluid pump according to claim 1, comprising at least one of the following features:
wherein the seal comprises a polymer;
wherein the supporting body comprises a material selected from the group consisting of: a ceramic; a metal; a hard metal; a hard plastic material; polyaryletherketone; polyetheretherketone; polyetherketone; polyetherketoneketone; polyetherketoneetherketoneketone;
wherein the piston comprises at least one material selected from the group consisting of: zirconium oxide; sapphire; hard metal; and silicon carbide;
wherein at least one of the supporting body or the piston has a coating of diamond on a hard metal body.

17. The fluid pump according to claim 1, wherein the fluid pump is formed as a high-pressure pump for pumping a mobile phase as a fluid to a separation device of the sample separation device for separating different fractions of a fluidic sample being in the mobile phase.

18. The fluid pump according to claim 1, wherein the bearing is a radial bearing.

19. The fluid pump according to claim 1, wherein the supporting body is configured as a radial bearing, which holds a gap between the supporting body and a piston surface and enables a piston surface of the piston to get in a permanent or at least temporarily physical contact with an opposite surface of the supporting body according to existing radial bearing forces.

20. A sample separation device for separating in fractions a fluidic sample in a mobile phase, the sample separation device comprising:
the fluid pump according to claim 1, configured for driving the mobile phase and the fluidic sample through the sample separation device; and
a separation device downstream of the fluid pump for separating the different fractions of the fluidic sample in the mobile phase.

21. (canceled)

22. A method for manufacturing a fluid pump for pumping fluid in a sample separation device, the method comprising:
arranging a piston in a reciprocable manner for conveying fluid in a pump body device;
arranging a seal in contact with, and fluid-sealingly between, the pump body device and the piston;
providing a supporting body, which is coupled to and supports the seal; and
arranging the supporting body at the pump body device, such that the supporting body forms a stationary bearing for the piston,
wherein the supporting body comprises a coating selected from the group consisting of: diamond; polycrystalline diamond; and, smoothed polycrystalline diamond.

23.-25. (canceled)
